(19) United States
(12) Patent Application Publication
(10) Pub. No.: US 2023/0107763 A1
(43) Pub. Date: Apr. 6, 2023

(54) TRUSTED EXECUTION MECHANISMS FOR PROTECTING CIPHER SOLUTIONS

(71) Applicant: VMware, Inc., Palo Alto, CA (US)

(72) Inventors: David E. OTT, Palo Alto, CA (US); Mark BENSON, Wokingham (GB); Daniel James BEVERIDGE, Valrico, FL (US); Marc Wayne BROTHERSON, Boulder, CO (US); Sean James HUNTLEY, Sydney (AU); Akeem Lamar JENKINS, Broomfield, CO (US); Dennis MOREAU, San Carlos, CA (US)

(73) Assignee: VMware, Inc., Palo Alto, CA (US)

(21) Appl. No.: 17/493,689

(22) Filed: Oct. 4, 2021

(51) Int. Cl. G06F 21/60; H04L 9/06; H04L 9/32

(52) U.S. Cl. CPC G06F 21/602; H04L 9/0618; H04L 9/3268; G06F 2221/2149

(57) ABSTRACT

This relates generally to protecting adjustable cipher solutions using trusted execution mechanisms. An example method includes, at one or more electronic devices, receiving a request for configuring a cipher solution for one or more cryptographic operations, retrieving one or more cryptographic policies from a first module protected by a secure enclave within a trusted execution environment, accessing one or more libraries in accordance with the one or more cryptographic policies, attesting the one or more libraries by verifying attestation data associated with the one or more libraries within a second module protected by the secure enclave of the trusted execution environment, and configuring the cipher solution for the electronic device based on attesting the one or more libraries.

### FIELD

The present disclosure relates generally to protecting cipher solutions, and more specifically, intelligently securing the cipher solutions and related data using trusted execution mechanisms.

### BACKGROUND

The demand for improvements in cryptography-based security measures continues to increase and scale with the increasing ability of processors to break through and defeat cryptography-based security measures. Substantial increases in processing power associated with the introduction of quantum computing makes these improvements even more necessary. Unfortunately, conventional cryptographic frameworks or cipher solutions are statically compiled or linked into the software applications and systems. This makes adapting to the rapidly changing security threat environment slow and costly since programmers are often needed to make manual changes to the software applications and systems to implement changes that keep the software applications and systems secure. In extreme circumstances, these systems and applications may be forced to reduce functionality or even shutdown until they are able to implement cryptographic features needed to ensure secure operations. Consequently, solutions or agility mechanisms that are protected from adversarial tampering with abilities to quickly make adjustments or changes to cipher solutions or cryptographic frameworks depending on a user's requirements and circumstances are desirable.

### SUMMARY

This disclosure describes protecting a cipher solution using trusted execution environments.

A computer implemented method is performed on a server associated with a cloud management platform, and includes the following: receiving a request for configuring a cipher solution for one or more cryptographic operations, retrieving one or more cryptographic policies from a first module protected by a secure enclave within a trusted execution environment, accessing one or more libraries in accordance with the one or more cryptographic policies, attesting the one or more libraries by verifying attestation data associated with the one or more libraries within a second module protected by the secure enclave of the trusted execution environment, and configuring the cipher solution for the electronic device based on attesting the one or more libraries.

A non-transitory computer-readable storage medium that stores instructions configured to be executed by one or more processors of a computing device associated with a cloud management platform is disclosed. The non-transitory computer-readable storage medium when executed by the one or more processors cause the computing device to carry out steps that include: receiving a request for configuring a cipher solution for one or more cryptographic operations, retrieving one or more cryptographic policies from a first module protected by a secure enclave within a trusted execution environment, accessing one or more libraries in accordance with the one or more cryptographic policies, attesting the one or more libraries by verifying attestation data associated with the one or more libraries within a second module protected by the secure enclave of the trusted execution environment, and configuring the cipher solution for the electronic device based on attesting the one or more libraries.

An electronic device is disclosed and includes one or more processors; persistent storage, comprising an encrypted region; non-persistent storage; and memory storing one or more programs configured to be executed by the one or more processors, the one or more programs including instructions for: receiving a request for configuring a cipher solution for one or more cryptographic operations, retrieving one or more cryptographic policies from a first module protected by a secure enclave within a trusted execution environment, accessing one or more libraries in accordance with the one or more cryptographic policies, attesting the one or more libraries by verifying attestation data associated with the one or more libraries within a second module protected by the secure enclave of the trusted execution environment, and configuring the cipher solution for the electronic device based on attesting the one or more libraries.

Other aspects and advantages of the invention will become apparent from the following detailed description taken in conjunction with the accompanying drawings, which illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1 shows a block diagram illustrating a software application or system equipped with a conventional cryptographic library.

FIG. 2 shows a block diagram illustrating an exemplary software application or system 200, in accordance with the described embodiments.

FIG. 3A shows a block diagram illustrating an implementation of a cryptographic selection system embedded within a software application, in accordance with the embodiments described herein.

FIG. 3B shows a block diagram illustrating an implementation of a cryptographic selection system within a software application using a trusted execution environment, in accordance with the embodiments described herein.

FIG. 4 shows a flow diagram illustrating a process for configuring a cipher solution for cryptographic operations based on attesting cryptographic libraries using a trusted execution environment, in accordance with the embodiments described herein.

FIG. 5 shows a flow diagram illustrating a process for selecting a cipher solution based on contextual information using a trusted execution environment, in accordance with the embodiments described herein.

### DETAILED DESCRIPTION

Certain details are set forth below to provide a sufficient understanding of various embodiments of the invention. However, it will be clear to one skilled in the art that embodiments of the invention may be practiced without one or more of these particular details. Moreover, the particular embodiments of the present invention described herein are provided by way of example and should not be used to limit the scope of the invention to these particular embodiments. In other instances, hardware components, network architectures, and/or software operations have not been shown in detail in order to avoid unnecessarily obscuring the invention.

Cryptographic frameworks and algorithms are a foundation of security protocols used by many software applications and systems for secure communications. Due to cyber security threats from quantum computing, malware, phishing, and the like to secure communications, cybersecurity algorithms are constantly evolving to protect against evolving cyber threats. Updating software applications or systems to incorporate latest cybersecurity algorithms and security protocols using existing interfaces can be complicated and may require a user or an organization to spend a considerable amount of time.

In addition to constantly updating the cryptographic algorithms and security protocols, software applications may be required to support alternative cryptographic algorithms and/or security protocols depending on state or context of the user using the applications or system, a state of the device used by the user for accessing resources, and the like. For example, weak or compromised algorithms may need to be replaced with strong algorithms when a user is trying to access a resource, create a secure communication, verify identity, verify integrity of a software, or conduct different operations from a network at high security threat area. Accordingly, depending on the circumstances surrounding a user or a user device, different algorithms from a range of cryptographic algorithms may be required for protecting secure data. Cryptographic agility mechanisms allow dynamic selection of cryptographic algorithms and key configuration parameters for optimal protection by leveraging multiple cryptographic libraries.

By implementing agility mechanisms external to the software applications or systems, the agility mechanisms are subject to new security threats and tampering. These agility mechanisms require protection from tampering. The ability to protect adjustable or reconfigurable cryptography agility solutions provides another layer of security and protection to sensitive data and operations. When cryptographic operations are decoupled from an application or a system and configured using different cryptographic agility mechanisms, the application or system and cryptographic agility mechanisms are likely to face additional security threats. Adversaries may tamper with cryptographic libraries, configuration rules, and overall cryptographic agility functionality. For example, an adversarial tampering or an attack to the cryptographic agility solutions may come from a rogue software process on a system that gains root privilege, a compromised operating system or other software or system components, an adversary who logs into as root and attempts to modify the system, an unwitting admin who installs software infected with malware or containing vulnerabilities that facilitate an adversarial attack, and the like.

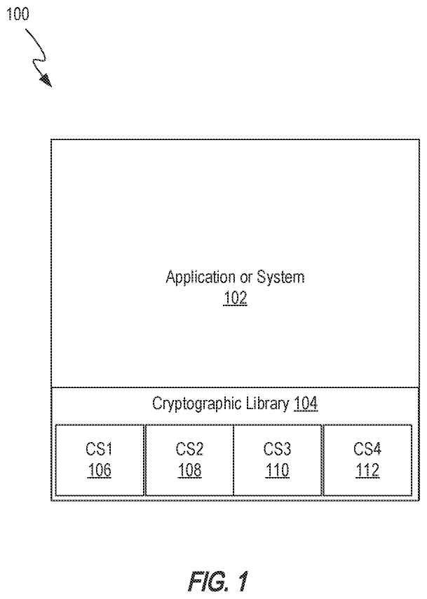

The present embodiments provide protection against adversarial tampering of cryptographic agility solutions or frameworks by using trusted execution mechanisms. The invention provides hardware-rooted mechanisms for isolating and protecting cryptographic agility related components, data, and computation using trusted execution environments such as Intel SGX, ARM TrustZone, AMD SEV, and RISC-V Keystone. These and other embodiments are discussed below with reference to FIGS. 1-5. Those skilled in the art, however, will readily appreciate that the detailed description given herein with respect to these figures is for explanatory purposes only and should not be construed as limiting.

FIG. 1 shows a block diagram illustrating a software application or system 102 equipped with a conventional cryptographic library 104. Cryptographic library 104 includes cipher suites 106-112. In some embodiments cryptographic library 104 can include a larger or smaller number of cipher suites. Each of the cipher suites typically includes multiple related ciphers that can be implemented alone or in combination to implement one or more cryptographic features. The cryptographic features enabled by cryptographic library 104 are generally implemented by hard coding references to the cryptographic features of cryptographic library 104 into software or application system 102. Therefore making any updates to the many features and protocols supported by cryptographic library 104 can be a manual time consuming process.

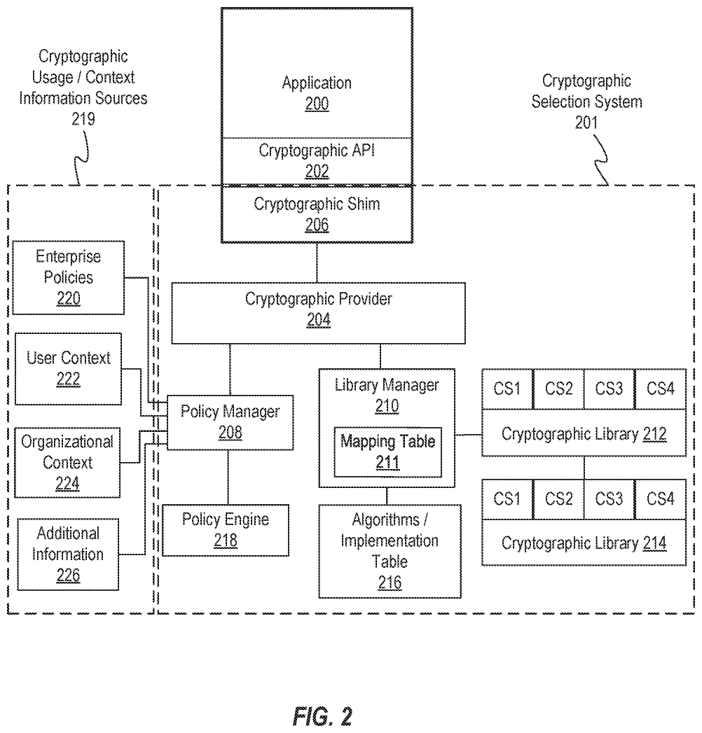

FIG. 2 shows a block diagram illustrating an exemplary software application or system 200 that includes a cryptographic selection system 201 in accordance with the described embodiments. Application 200 includes a cryptographic API 202 for generating abstracted cryptographic API calls when operation of application 200 requires a cryptographic feature such as, e.g., digital signatures, cryptographic hardware acceleration or some other form of cryptographic protocol. Cryptographic shim 206 is configured to intercept calls made by cryptographic API 202 and forward the cryptographic API calls to cryptographic provider 204. In some embodiments, cryptographic shim 206 performs some amount of translation or adaptation to the abstracted cryptographic API calls prior to forwarding the API calls to cryptographic provider 204. For example, cryptographic shim 206 can be configured to perform any one of the following actions: pad parameter values generated by application 200 so they are the right width to be accepted by a particular cryptographic feature; map parameter types between schema; navigate library function calls with different numbers or ordering of input parameters; initialize a cryptographic library prior to passing on function calls supported by the cryptographic library; navigate and populate any special parameters specific to a particular cryptographic feature such as an error flag, an entropy parameter, or the like; interpret the return value of a library function call (e.g. library specific code values indicating success or error); and translate a generic call to a specific number of security strength bits for a specific cryptographic feature.

Cryptographic provider 204 is then responsible for processing the API calls received from the cryptographic shim and interacts with two primary modules: policy manager 208 and library manager 210 to assist in executing the abstracted cryptographic API calls generated by application 200.

Library manager 210 is configured to manage cryptographic libraries. While library manager 210 is depicted managing cryptographic libraries 212 and 214 it should be appreciated that library manager 210 can be configured to manage any number of cryptographic libraries needed to support the operation of application 200. Library manager 210 is responsible for providing access to one or more cryptographic features included in cryptographic libraries 212 and 214 in response to the API calls received by cryptographic provider 204. Library manager 210 is also configured to assist with updating existing cryptographic features and registering new cryptographic features. A cryptographic feature can take the form of a cryptographic algorithm, protocol, function, or combination of cryptographic algorithms, protocols or functions.

In some embodiments, library manager 210 includes a mapping table 211, which associates particular cryptographic features with tags configured to associate the cryptographic features contained within cryptographic libraries 212 and 214 with particular functions and capabilities. Whenever updates are made to one of cryptographic libraries 212 and 214, library manager 210 is configured to update mapping table 211 to associate any new or updated cryptographic features with one or more tags.

New cryptographic features can be added to cryptographic selection system 201 by first referencing algorithms/implementation table 216, which can include a listing and/or locations of all potential cryptographic algorithms, libraries, functions, rules and the like compatible with cryptographic provider 204 and then selecting one or more cryptographic features from algorithms/implementation table 216 for registration with cryptographic selection system 201. It should be noted that, while algorithms/implementation table 216 is depicted as being directly attached to library manager 210, algorithms/implementation table 216 can also be maintained and/or stored at a location outside of an attached storage or a local network.

In some examples, library manager 210 can be managed using a user interface operated through application 200 and/or through another management application. The user interface allows a user to register one or more new cryptographic features listed in algorithms/implementation table 216 to update cryptographic selection system 201. For example, an administrator could access the user interface to configure one or more of the cryptographic libraries with cipher suites supporting different bit rates or types of encryption.

Policy manager 208 is responsible for managing policy engine 218. Policy engine 218 can take the form of a user-defined and/or autonomously compiled list of policies that establish rules for the operation of cryptographic selection system 201. Policy engine 218 can be implemented as a rule engine, a table, a neural network or the like. The list of policies stored in policy engine 218 affect how library manager 210 of cryptographic provider 204 operates to manage implementation of various cryptographic features included in cryptographic libraries 212 and 214. When an API call is received at cryptographic provider 204, cryptographic provider 204 leverages the list of policies contained in policy engine 218 and managed by policy manager 208 to select one or more cryptographic feature suitable for handling the abstracted cryptographic API call. In some embodiments, policy engine 218 specifies a particular cryptographic feature or features contained within one of cryptographic libraries 212 and 214 for use in response to an API call.

In some embodiments, a policy associated with the API call specifies a tag identifying a solution class defined and maintained within mapping table 211. The identified cryptographic feature or tag is then transmitted to library manager 210. In the case a tag is transmitted to library manager 210, library manager 210 uses mapping table 211 to identify which cryptographic feature or features is associated with the tag. Library manager 210 then instructs cryptographic provider 204 which cryptographic feature or features to implement in response to the received API call. It should be noted that in some embodiments an API call can be associated with multiple tags. This set of cryptographic features used in responding to the API call can be referred to as a cipher solution. This system of using tags associated with functionality in the policy engine instead of particular cryptographic functions allows library manager 210 and policy manager 208 to operate independently from one another. This reduces the need for coordination between the library and policy managers outside of passing tags from the policy manager to the library manager. It should be noted that while FIG. 2 shows any communication between the library manager and policy manger are routed through the cryptographic

In some embodiments, the abstracted cryptographic API call can take the form of a request for data encryption of a particular type of data. A first policy associated with the API call can specify that the encryption for that type of data be of a specific type (e.g., FIPS compliant encryption) and a second policy associated with the API call can specify that the encryption be of a minimum security strength (i.e. number of bits) or key size for the specified type of data associated with the API call.

In some embodiments, policy engine 218 can be managed at least in part autonomously by making changes to enterprise policies 220. Enterprise policies 220 is one of cryptographic usage/context information sources 219 and are generally managed by a network administrator, allowing for hierarchical network-wide implementation of policies for managing multiple applications having cryptographic frameworks in accordance with the described embodiments. In some embodiments, policy engine 218 can include policies selected based on user context 222, organizational context 224 and/or additional information 226. User context 222 can include data such as a user's location, the user's identity, the nature of the data to be protected, the user's access level, the speed and/or characteristics of the local network the user is accessing, the geographic location of the user, the application context and more. In embodiments where policy engine 218 includes tags identifying particular desired functionalities, in lieu of specifying particular cryptographic features, policy engine 218 assigns the policies it manages tags configured to meet security requirements specified by the enterprise policies.

In some examples, user context 222 would be supplied to cryptographic provider 204 to assist in selection of the right cryptographic feature to meet a respective abstracted cryptographic API call. For example, a policy stored within policy engine 218 could specify that higher minimum levels of encryption are required for users operating outside of a trusted network environment. The higher minimum level of encryption can be specified by a particular tag in the policy corresponding to a specific level of encryption associated with that tag and identified in mapping table 211. When user context 222 indicates the user is operating outside the trusted network, that higher minimum level of encryption rule would be applied when cryptographic provider 204 is selecting a suitable cryptographic feature for responding to a respective API call.

In some examples, entire cryptographic libraries can be dedicated to handling API calls associated with users of a specific type or operating from a particular location. Organizational context 224 can apply in a similar manner to user context 222. For example, applications grouped under a first organization might have a different set of policies than applications grouped under a second organization. These types of policies would generally be implemented by an information security IT team for each organization. For example, the organizational policies might specify different cryptographic features be used in different regions of the world or that different cryptographic features be used based on which business sector or project the request for access is associated with. In some embodiments, certain policies such as FIPS compliant cryptography could be required for all communications associated with a particular company or organization.

Additional information 226 can include other types of contextual information, such as, for example, certificate alert information for a particular usage context (e.g. transactions utilizing systems running Windows 10 versions a threshold number of versions old and/or versions containing a known critical security vulnerability can be identified as they may require additional security mitigation).

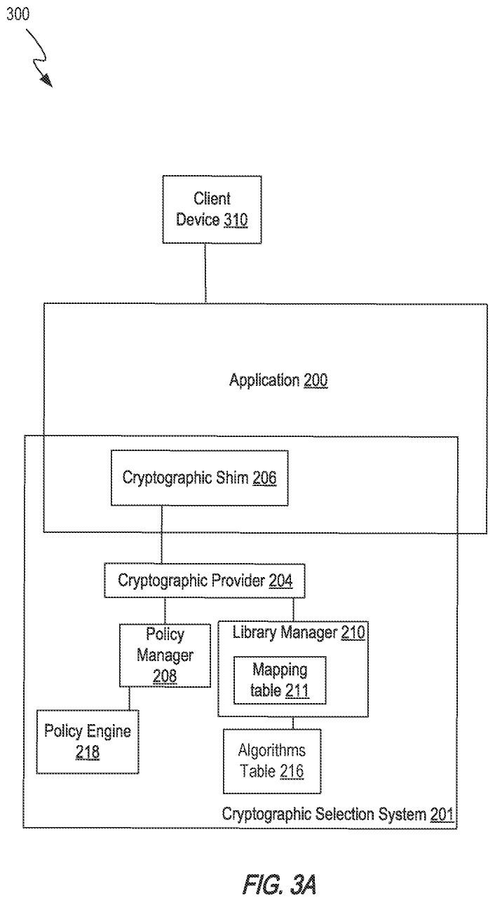

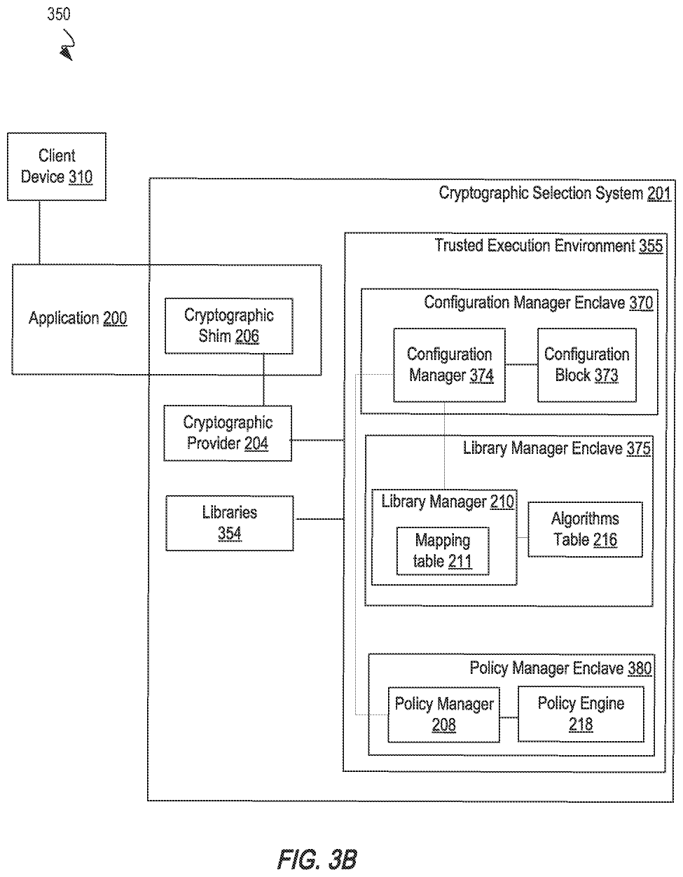

FIG. 3A shows a block diagram illustrating an implementation of a cryptographic selection system embedded within a software application, in accordance with the embodiments described herein. FIG. 3A depicts cryptographic system 300 which includes a client device 310 that may represent a computing or a processing device. In the above examples, the client device 310 may be a desktop computer, a mobile telephone or smartphone, a personal digital assistant (PDA), a laptop computer, or a tablet computer. In some examples, the client device 310 may be a computing device or a server device in communication with a different computing device.

In some examples, the client device 310 may interact with at least one server(s) or other computing device(s) over a communications network. The client device 310 may communicate with other computing device(s) or servers (e.g., application 200) over a network directly or indirectly via any suitable intermediate device(s) or network(s). For example, the client device 310 may communicate via one or more cellular base stations or one or more wireless access points such as IEEE 803.11. In some examples, the client device 310 may direct a user's request to an application 200 within the system 300. The application 200 may be a web application, a computing environment hosted on a server, or a data file on a server. In some examples, the application 200 may be installed on the client device 310 or is accessible from the client device 310 using a web browser.

In some examples, the application 200 may enable a user to perform different actions such as accessing one or more resources or secure data at a server, securely communicate with other devices, and the like from the client device 310. A server hosting the application 200 may be any type of known computer, server, or data processing device. The server may further include RAM, ROM, network interface, input/output interfaces, and memory. The one or more resources or secure data may reside on a server hosting the application 200 or on a different device or a server connected to the application 200 through the network, via direct or indirect connection or some other network.

In some examples, a user's requests or queries from client device 310 are directed to the application 200. The application 200 may be capable of handling cryptographic operations involving modern cryptography standards using the cryptographic selection system 201. The cryptographic selection system 201 enables automated configurations and adjustments to cipher solutions for providing secure data access, communications and other operations for the application 200. Specifically, the cryptographic selection system 201 enables automated selection and configuration of cryptographic libraries (or algorithms within libraries) based on contextual information (e.g., user context 222) or key facts surrounding the user and user device such as user's access level, the speed and/or characteristics of the network the user is accessing, the geographic location of the user, the sensitivity of data being protected, user roles participating in a data exchange, the network context, the characteristics of devices involved, the nature of the application, and the like. In some examples, contextual information may be a user's identity, a device type (e.g., personal, company, etc.), nature of data (e.g., confidential, person, public, etc.), nature of application (e.g., company database, web service, etc.), network (e.g., enterprise or outside US), and the like.

Based on the contextual information, sets of policies and available libraries, the cryptographic selection system 201 automatically selects among cryptographic algorithm alternatives and key configuration parameters for optimal protection to operations involving the application 200. The cryptographic selection system 201 may determine a situation surrounding the user and the user's device, determines what cipher solution (e.g., selection of algorithms and/or libraries) is required to process the user's transaction(s), and configure or select cipher solution for processing the user's request(s). In some examples, the cipher solution is a solution or framework required for one or more cryptographic operations for processing a user's request for one or more operations involving the application 200. Specifically, a cryptographic solution is a selection of one or more libraries, algorithms, functions, or processes. Updates to the cipher solution or selection of a cipher solution can be based on cryptographic policies, available algorithms and libraries, and contextual information.

In some examples, the application 200 includes a cryptographic API (e.g., 202 as shown in FIG. 2) for handling cryptographic operations involving the application 200. In the above examples, in response to a user's request, the cryptographic API may be used for interacting with and making calls to a cryptographic provider 204 for handling cryptographic operations. The cryptographic shim 206 is configured to transparently intercept calls to cryptographic API and makes generic calls to the cryptographic provider 204 for handling any cryptographic operations using policy manager 208 and library manager 210.

In some examples, library manager 210 is configured to manage cryptographic libraries. In some embodiments, library manager 210 can include three or more cryptographic libraries. Each of the cryptographic libraries can be configured to be implemented in accordance with information provided by policy manager 208. In some examples, the library manager 210 can be managed using a user interface operated through application 200 and/or through another management application. In some examples, the library manager 210 can be managed by an API used to build configurations related user interface applications. In some examples, policy manager 208 may have access to one or more user-defined, enterprise policies and/or autonomously compiled list of policies dictating the operation of cryptographic provider 320. The list of policies affect how library manager 208 of cryptographic provider 204 operates to manage implementation of various cryptographic features governed by cryptographic libraries.

In some examples, the policy engine 218 may include mapping between contextual information (or context data 222) associated with the user and one or more cipher solutions. A cipher solution may be a framework or configuration identifying one or more algorithms and/or libraries for handling cryptographic operations. In the above examples, a software system or application may be used within an organization to configure the policy description engine 218. The application may configure the policy description engine 218 with policies for data centers, edge computing environments, federated cloud information, and other infrastructure components. The application may allow a user to create, modify, and maintain cryptography operations within the organization after configuring the components with the policy description engine 218. An example policy may suggest that if a user or client device is outside the company network then use a TLS 1.3 protocol for cryptographic operations. An example policy may suggest if a communication from the client device is related to a health care application then use FIPS-certified suit. An example policy may suggest if the application 200 includes confidential product roadmap information or intellectual property then use a hybrid quantum safe cipher suite for the communication involving the application.

In some examples, the policy manager may map contextual information with a class or a tag instead of a specific library or algorithm. The nature of the class may be determined by a user of cryptographic selection system 201. A class may identify a level of crypto security that should be used and further provide distinctions that an organization would find meaningful. For example, different classes may be designated for different categories such as top secret, confidential, FIPS, non-FIPS, hand-held device policy, server policy, and the like.

In some examples, a cryptographic standard may be designated as a class that is matched to tags registered within a library. In the above example, according to an example policy, if the user of client device 310 is operating in Iran and provides a request to access classified data, then a cipher solution associated with a class tag “Class: Classified” may be used. In the library (e.g., 214) there may be multiple cipher solutions (e.g., quantum safe cipher solution) which are A different cipher solution matching the same tag may be used if the user is trying to access data from Iran versus the United States. In some examples, a tag may be a set of Boolean conditions which may chain several inputs with logical OR/AND conditions between the inputs (or contextual information). The tag may govern a selection of a cipher solution from registered cipher solutions in the library. For example, a tag may be if a user is a senior executive AND the user is “outside of the home country,” then apply a cipher solution of class “XYZ.” In some examples, a list of policies may be mapped to users' profiles. Accordingly, upon detecting a specific user, a set of policies and tags associated with the user's profile may be used for processing the user's request for actions involving cryptographic operations.

In some examples, the mapping table 211 may be an expanded policy engine 218. Specifically, the mapping table 211 may be a policy engine 218 that includes mappings or pointers for contextual information, a list of policies, a list of libraries, a list of algorithms, and the like. Alternatively, the mapping table 211 may be a separate table from the policy engine 218 that includes mappings or pointers between tags or classes from the policy engine 218 to one or more libraries or cryptographic algorithms accessible by the library manager 210. The mapping table 211 may include mappings or pointers between one or more cryptographic algorithms or libraries (within algorithms table 216) and one or more policy data (e.g., class or tags associated with the policy engine 218). The mapping table 211 may act in conjunction with a policy engine or can also take over the functions of the policy engine (see, e.g., policy manager 208 from FIG. 2).

In the above examples, a user using the client device 310 may request to access one or more secure data or resources associated with the application 200. Accordingly, a user request for accessing secure data or resources may be generated. In some examples, upon generating the user request, the client device 310 may direct the user request to an IP address (using IPv4 or IPv6 protocol format) of a server hosting the application 200. The client device 310 may direct the packets containing the user request and user's contextual information to the application 200. The contextual information may include information associated with the user, the client device 310, the network connection used by the user, or any other information associated with the user, device and/or network used by the client device 310. The contextual information may be determined based on the identifying a location of the client device 310 (e.g., IP location, GPS location, etc.). The contextual information may be determined when a user of the client device 310 requests an access to certain applications or data. The contextual information is shared with the policy engine 218 for the policy engine 218 to select an appropriate cipher solution.

In some examples, different sets of mechanisms may be used to collect contextual information to be used by the cryptographic selection system 201. The application 200 may provide context information to the provider 204 (or a processor associated with cryptographic selection system 201) using API calls. In some examples, the provider 204 may check operating system or container level information including configuration data for application 200 and client device 310 to determine contextual information. Further, information about the user's configuration may help determine contextual information. For example, if the application 200 is configurable using API or UI, the provider may determine that the application 200 may be using a certain standardized approach (e.g., FEDRAMP). In some examples, contextual information may be determined based on inspecting packets from the client device 310. In some examples, an organization may have a software that collects the contextual information and makes the information available via an API or file that is available to the policy manager 208. Alternatively, the policy manager 208 may collect the activities associated with the contextual information from the operating system and other information sources.

In the above examples, to further process the user's request, the crypto shim 206 may act as a library that intercepts a call or request for cryptographic operations within the application 200 and redirects the calls or the requests to the cryptographic provider 204. Within the application 200, security operations may be performed over the cryptographic selection system 201. In the above examples, the cryptographic provider 204 or policy manager 208 may obtain and analyze the contextual information received. For example, the cryptographic provider 204 may identify the location of the user's device based on the contextual information. Similarly, the cryptographic provider 204 may determine other information specific to the user, user device, network security of the user device, and type of access requested by the user.

In some examples, a device or client associated with the provider 204 may obtain contextual information by requesting a communication session with an application server associated with the application 200 and/or client device 310. The context information is then used by the policy manager 208 to make an automated decision on which cipher solution to use or change in the configured cipher solution. In some examples, if the user requests access to highly sensitive data from the application 200, the application 200 can signal the policy engine 218 to invoke a change in a cipher solution based on the changed data access context (e.g., location of the user device 310).

The cryptographic provider 204 may further compare the contextual information with corresponding policies and cipher solutions within the policy engine 218. The policy engine 218 (or the cryptographic provider 204) may determine a cipher solution for performing the cryptographic operations for processing the user request. The mapping table 211 may include mappings of at least one of cipher solutions, one or more available libraries, and cryptographic algorithms. The cryptographic provider 204 may configure the determined cipher solution (or selected algorithms) for processing the user's request.

In the above examples, upon determining the cipher solution for processing the user's request, the cryptographic provider 204 executes the one or more algorithms according to the cipher solution to authenticate or process the user's request. The one or more cryptographic algorithms include a one way hash function, symmetric key encryption, public key encryption, digital signature, and other types of predefined or customized cryptographic algorithms. Accordingly, proper security measures are followed in processing the user's request to ensure secure communication. In the above examples, a policy and libraries (or algorithms within the libraries) are instantiated in real-time for configuring the cipher solution based on the contextual information.

In alternative examples, the cryptographic provider 204 may have a default or present cipher solution defined for all user's requests. Accordingly, upon receiving the user's request and contextual information, the cryptographic provider 204 may evaluate the present or default framework configured for processing the user's request. In some examples, the cryptographic provider 204 may determine that the present cipher solution (e.g., cryptographic algorithms) is not suggested for processing the user's request based on the received contextual information and the mapping table 211. In the above examples, the cryptographic provider 204 may change or adjust the present cipher solution to include one or more different cryptographic algorithms and/or libraries. Alternatively, the cryptographic provider 204 may determine that the current framework or cipher solution does not need to be updated in accordance with the contextual information.

In alternative examples, the provider 204 may compare contextual information with the contextual information associated with the present or default configuration or framework for performing cryptographic operations. If the contextual information is unchanged, the provider 324 does not further evaluate the contextual information against the mapping table 211 and use the default or present framework for processing the user's request.

In some examples, in response to determining that the present or default cipher solution needs to be updated, the cryptographic provider 204 updates or reconfigures the cipher solution based on the contextual information and mapping table 211. Upon implementing an update to the cipher solution, the cryptographic provider processes the user request by executing the selected cryptographic algorithm(s) in accordance with the updated cipher solution. The above described process may be performed every time a user request needs to be processed using cryptographic operations within the application 200.

In the above examples, as discussed, the policy manager 208 may determine which cipher solution to use based on contextual information. The policy engine 218 may take a set of inputs (e.g., context information), process the inputs with rules or policies, and output a tag representing a class needed for processing the user request. Upon receiving the information from the policy manager 208, the information may be forwarded to the library manager 210 using one or more APIs supported by the library manager 210.

Upon receiving the information, the library manager 210 may identify correct libraries and obtain access to the libraries using either direct or intermediary mode. In the above examples, a cryptographic library may have one or more cipher solutions with parameters registered and tagged to a same tag that is outputted from the policy manager 208. In direct mode, the library manager 210 may make a call to access the required libraries and/or algorithms and direct the output (pointers to the set of libraries or algorithms) back to cryptographic provider 204 caller (e.g., application 200). In intermediary mode, the library manager 210 may make a call to access the required libraries and/or algorithms and direct the output (pointers to the set of libraries or algorithms) back to the cryptographic provider 204 caller (e.g., application 200) with no indirection turned off. Accordingly, in intermediary mode with indirection turned off, the library manager 210 may make a call to access the required libraries and/or algorithms and in response only receives the specific libraries it requested. If the required library references other libraries, with indirection turned off, the library manager 210 does not retrieve the other libraries.

In the above examples, in response to the user's request a call to the cryptographic provider 204 may be directed to a specific library, an algorithm family within library (from the algorithms table 216), and a specific function call associated with the algorithm family using different types of input parameters required by the algorithms. In other examples, the steps of communication between cryptographic provider 204, library manager 210 and policy manager 208 may vary with different methods of operations.

In the above examples, the cryptographic selection system 201 and components within the system 201 (e.g., the library manager 210, the policy manager 208, mapping table 211, algorithms/implementation table 216, policy engine 218), as shown in FIG. 3A, are vulnerable to adversarial attacks and tampering. For example, an adversary may attack the system 201 by adding a compromised library to the library manager 210 or by tampering with the library manager 210. In another example, an adversary may tamper with algorithms table 216 by preventing a secure algorithm from being visible. An adversary may tamper with the mapping table 211 by remapping a tag or class from a secure algorithm to an insecure algorithm. An adversary may tamper with the system 201 by modifying the library manager or manager function pointer to read the mapping table 211 incorrectly. Similarly, an adversary may tamper with the policy manager 208 by modifying a table or function pointer associated with the policy engine 218 or modifying the manager 208 to read the policy engine 218 results incorrectly. To protect against adversarial tampering and attacks, the cryptographic selection system 201 may be implemented using a trusted execution environment using techniques disclosed in FIG. 3B descriptions.

FIG. 3B shows a block diagram illustrating an implementation of a cryptographic selection system within a software application using a trusted execution environment, in accordance with the embodiments described herein. The implementation discussed in FIG. 3B protects the policy manager 208, the policy engine 218, the library manager 210, enterprise policies 220, cryptographic libraries 212 and 214 and other data or processes involving the cryptographic selection system 201 in a trusted execution environment 355. Specifically, to protect against adversarial tampering, to establish trust, and to provide auditing capabilities, the trusted execution environment 355 may be used for implementing cryptographic agility mechanisms described in FIG. 3A. Different trusted execution environments (e.g., Intel SGX, ARM TrustZone, AMD SEV, RISC-V Keystone, and the like) may provide hardware-rooted mechanisms for isolation and attestation of cryptographic selection system related components, data, and computations in order to protect against adversarial tampering and to establish trust. To set up trusted execution environment protection, the following actions are performed while configuring the cryptographic selection system 201 associated with application 200.

In some examples, to set up cryptographic selection system 201 using a trusted execution environment 355, the cryptographic provider 204 may set up a configuration block 373 that is cryptographically hashed and digitally signed by an administration team while provisioning the application 200. Alternatively, the cryptographic provider 204 may set up the configuration block 373 using non-cryptographic hash functions. Further, at a start-up time of an application 200 or any system that incorporates a cryptographic selection system 201, the cryptographic provider 204 may create a configuration manager enclave 370 and initialize configuration manager 374 and configuration block 373. The cryptographic provider 204 may use trusted execution mechanisms (e.g., Intel SGX) to create an attestation report of the configuration manager enclave 370 for determining integrity of the configuration manager enclave 370. The report can be manually verified by administrators and/or third party auditors, or verified by an application/system-specific subsystem doing the verification in an automated way.

In some examples, the configuration manager 374 may create a library manager enclave 375 and library manager 210, and configure the library manager 210 with registered library information. In some examples, a registered library is a library incorporating one or more cryptographic algorithms that have gone through the registration process with a trusted execution environment (e.g., 355). To protect integrity of the information within the library manager 210, each of the permissible cryptographic libraries may undergo a registration process. Either an application developer or an enterprise user may compute a cryptographic hash of the library and then digitally sign the hash to register a library. The registration is further added to the configuration block 373 which will be loaded and verified at startup time by the configuration manager 374. In alternative implementations, both configuration manager 374 and configuration block 373 may be implemented as part of the library manager 210. In the above examples, while the registered library information is stored within the library manager 210, the library itself may be stored outside the trusted execution environment 355 depending on the size of the library, as shown in FIG. 3B (e.g., libraries 354).

After the creation of the library manager enclave 375, the cryptographic provider 204 may use trusted execution mechanisms (e.g., Intel SGX) to create an attestation report of the library manager enclave 375 to verify its integrity. The report can be manually verified by administrators and/or third party auditors, or verified by an application/system-specific subsystem doing the verification in an automated way. In some examples, the configuration manager 374 may verify attestation reports. Accordingly, the library manager 210 cryptographically hashes the libraries and compares against the signed versions to further verify that they have not been tampered. After this verification, the libraries are added to the service (e.g., dynamically configured) in a manner required by the software runtime or the programming language environment.

In some examples, the application 200, cryptographic provider 204, a system software, or auditing agent can request attestation of the library manager 210. In response, a measurement may be taken by a processor within the trusted execution environment 355, and a report is generated which is digitally signed by the trusted execution environment platform (e.g., Intel SGX). The report is passed to the requester directly by the trusted execution environment platform. In some examples, the library manager 210 may create a digitally signed hash for each library and store it in the algorithms table 211. Alternatively, any other components (e.g., configuration manager 374) within the trusted execution environment 355 may perform the hashing for each library and request the library manager 210 to store it within the algorithms table 211. Periodically, or upon request from the cryptographic provider 204, a system software, or Auditing Agent, the library manager 210 may rehash the library and compare the results against the expected stored value within the algorithms table 211.

In some examples, the configuration manager 374 may further create a policy manager enclave 378 including the policy engine 218. The policy engine 218 may be verified using a similar verification method as library verification described above. The policy manager 208 may cryptographically hash the data within the policy engine 218 and compare against the configuration block information to verify the integrity of the policy engine 218. Alternatively, any other components (e.g., configuration manager 374) within the trusted execution environment 355 may perform hashing for the data within the policy engine 218.

To enable verification for the policy engine 218, at deployment time, the administrator may compute a cryptographic hash of the policy engine 218 or a table of policies associated with the policy engine 218, and digitally sign the hash (similar to library registration). This is added to the configuration block 373 which may be loaded and verified at startup time. In some examples, the application, system software, or auditing agent may request attestation of the policy manager 208 through the crypto provider 204. In response, a measurement will be taken by the trusted execution environment mechanisms and a report may be generated which is digitally signed by the trusted execution environment platform (e.g., Intel SGX). The report is passed to the requester directly by the trusted execution environment platform.

In the above examples, once the cryptographic selection system 201 components (e.g., 370, 374, 373, 375, etc.) are set up within a trusted execution environment 355, the following steps may be performed during execution of cryptographic operations to process a user's request for performing various actions such as accessing secure data, initiating a secure communication, and the like.

Upon receiving the user's request at the application 200, the application 200 may handover the user's request and other information of the user to the cryptographic provider 204 via the cryptographic shim 206. In some examples, upon receiving the user's request, the cryptographic provider 204 may query the policy manager 208 using one or more APIs supported by the policy manager 208. The policy manager 208 may be running on policy manager enclave 380 with the policy engine 218. To determine a cipher solution (or a selection of algorithms and/or libraries) for processing the user's request, the cryptographic provider 204 may query the policy manager 208 for policies associated with the user request. In embodiments where the policy engine 218 includes tags or classes, the query may return tags associated with any policies governing execution of the user request. The policy manager 208 is generally configured to retrieve the information about the tags or classes by making API calls to the policy engine 218. Accordingly, APIs associated with policy manager 208 may respond to different policy engine 218 queries. Further, APIs associated with policy manager 208 may be used by the cryptographic provider 204 to manage updates to the policy engine 218. Further, APIs associated with policy manager 208 may enable a user to obtain digitally signed attestation reports upon request to further verify integrity of the policy engine 218. This authentication mechanism may be added to prevent calls to the policy manager 208 from any other source than the configuration manager 374 or administrative tools.

In some examples, upon receiving information from the policy manager 208, the cryptographic provider 204 may query the library manager within the enclave 375 to authenticate and access the libraries or algorithms within the libraries. In some examples, the library manager 210 is running on the library manager enclave 375 and may include information about available libraries (e.g., algorithms table 211). The libraries may be outside the secure enclave (e.g., enclave 376) as the libraries may be too large and the enclave may hamper its performance. Similar to policy manager, the library manager also provides APIs for one or more functions involving the libraries from the algorithms table 216 and mapping table 211. For example, the library manager 210 may use an API to respond to queries about configuration (e.g., use quantum safe library A). The library manager 210 may further manage calls or queries from cryptographic provider 204 (e.g., compute digital signature with library B) using an API. The library manager 210 may also provide digitally signed attestation reports upon request using APIs.

In some examples, the policy manager 208 may generate and attach a digital signature with the information (e.g., classes or tags associated with any policies governing an execution of a user request) obtained from the policy engine 218. Accordingly, when the information from the policy engine 218 is passed to the library manager 210 via the cryptographic provider 204, the library manager 210 may verify the integrity of the information from the policy engine 218. Using the digital signature, the library manager 210 can verify whether the cryptographic provider 204 has tempered with the information obtained from the policy engine 218.

In some examples, the policy manager 208 may directly communicate information or results (e.g., classes or tags associated with any policies governing an execution of a user request) obtained from the policy engine 218 with the library manager 210. In such instances, a cryptographic provider 204 or any other component within cryptographic selection system 201 is not used as an intermediary to ensure integrity of the information from the policy engine 218.

In some examples, for both policy manager 208 and library manager 210, an authentication mechanism may be added to prevent calls to either policy manager 208 or library manager 210 from another source than cryptographic provider 204 or administrative tools. In some examples, cryptographic provider 204 may call policy manager 208 and library manager 210 in any sequence. In some examples, to gain efficiency, the cryptographic provider 204 may query policy manager 208 first to determine policies and tags/classes (e.g., a cipher solution) for processing a user's request. After getting a response from the policy manager 208, the cryptographic provider 204 may initiate multiple calls to library manager to set-up and execute one or more algorithms for processing a user's request.

In some examples, different sets of actions or operations may follow after performing queries from cryptographic provider 204 to policy manager 208 and receiving information about policies and tags/classes (or libraries and/or algorithms) to use for processing a user's request. The set of actions or operations may include configuration action (e.g., link library B) to the application, a multi-call sequence of calls from cryptographic provider 204 to library manager 210 using information obtained from policy manager 208, and/or a single call between cryptographic provider 204 and library manager 210 for runtime cryptographic operations.

The implementation of the cryptographic selection system 201 within the trusted execution environment 355 using the above described techniques provides runtime isolation and attestation for cryptographic operations involving the application 200. As shown in FIG. 3B, both software processors and data (e.g., mapping table 211) are isolated from other software (e.g., application 200) running on the system. The above implementation using the trusted execution environment 380 may offer a secure way to measure or attest the content or data of the secure enclaves (e.g., 370). The implementation enables the cryptographic hash of the contents to be digitally signed for verification. The information involving hash and digital signature may be made available in the form of an attestation report as discussed. The report can be used by a verifier (e.g., part of the application, or part of an audit mechanism) who verifies the authenticity of the digital signer, and then verifies the cryptographic hash matches what is expected. Accordingly, the above process provides a cryptographic proof mechanism to verify the contents and integrity of what is loaded into the protected memory region (e.g., secure enclave 370) and other isolation mechanisms.

In addition, the above implementation addresses the problem of adversarial tampering in many ways. For example, upon startup, the configuration Manager 374, library manager 210, and policy manager 208 are loaded into memory enclaves where the attestation feature is used to generate attestation reports for them to verify their integrity. Similarly, the crypto provider 204 enables API requests for attestation reports from any of the three components (e.g., the configuration manager 374, library manager 210, and policy manager 208). As discussed, at startup, the application, system software, or an auditing agent may request and verify the attestation report from each of the three to ensure the authenticity and integrity of what has been loaded. In addition, as described above, verifying the library manager 210 using trusted execution environment attestation mechanisms by including measurements (e.g., hash values) for the library manager 210, algorithms table 216, and the mapping table 211 prevents an adversary from tampering with the library manager 210. Similarly, verifying the policy manager 208 using the trusted execution environment attestation mechanisms by including measurements of the policy manager 208 and policy engine 218 prevents an adversary from tampering with the policy manager 208.

Similarly, the implementation above prevents an addition of any compromised library to the library manager 210 by requiring a new library to be registered by components within the trusted execution environment 355. Specifically, to introduce a new library, the configuration manager 374 may measure the library image (e.g., cryptographic hash) and check it against a value for the library contained within the configuration block to verify the integrity of the library. Based on this verification, the library manager 210 may adjust the algorithms table 216 and/or mapping table 322.

In alternative implementations, the cryptographic selection system 201 may be implemented within a proxy component instead of the application 200. The proxy may serve as a front-end authentication and communication dispatch system for the application 200. For example, the proxy may encrypt or decrypt network packets associated with the user's request. Accordingly, a user's requests or queries from client device 310 are directed to the application 200 are received at the proxy. The proxy may include functions, rules or operations for processing security related protocols, such as SSL or TLS. The proxy may further include cryptographic shim 206, cryptographic provider 204, and one or more libraries. The cryptographic provider 204 may interact with components (e.g., configuration manager 374, library manager 210, etc.) within a trusted execution environment using similar methods, as described above in the FIG. 3B description.

In alternative implementations, the policy engine 218 may include information about one or more libraries and/or algorithms to be used for cryptographic operations based on contextual information. In this implementation, the policy manager 218 may obtain one or more libraries for cryptographic operations based on one or more policies and contextual information within the policy engine 218. The policy engine 218 may include a table showing mappings between the contextual information, policy rules, and one or more libraries and/or algorithms. Accordingly, a cryptographic provider 204 may query the policy manager 208 using a supported API to obtain one or more libraries and/or algorithms for processing a user request. In response to receiving information about one or more libraries and/or algorithms, the cryptographic provider 204 may query the library manger 210 to verify the integrity of the one or more libraries and/or algorithms, and configure them to be used for handling cryptographic operations for processing a user's request.

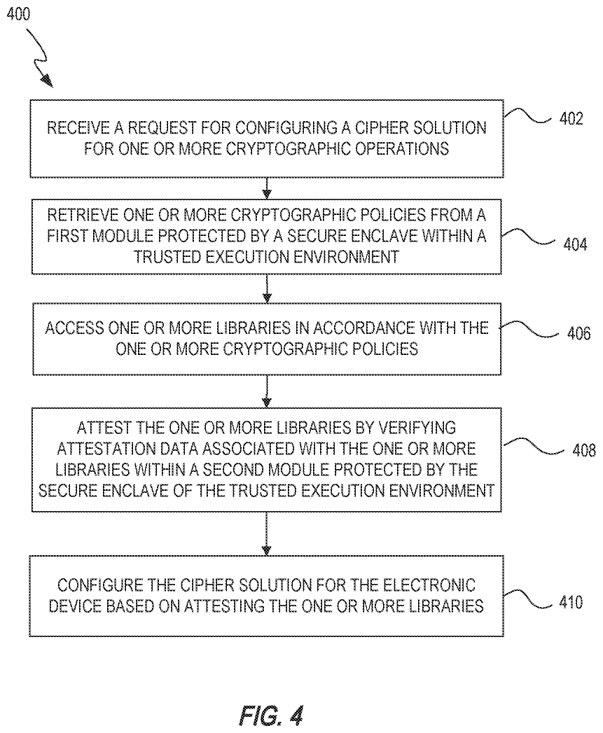

FIG. 4 shows a flow diagram illustrating a process for configuring a cipher solution for cryptographic operations based on attesting cryptographic libraries using a trusted execution environment, in accordance with the embodiments described herein. The steps shown in FIG. 4 may be performed over one or more client or server devices or processors within an electronic device. Alternatively, the steps shown in FIG. 4 may be performed by one or more processors within the cloud platform. In some examples, the steps as disclosed in FIG. 4 may be performed using one or more processors within a trusted execution environment.

In step 402, the electronic device receives a request for accessing one or more resources, initiating a secure communication, validating data, or for some other action that involves cryptographic operations. In some examples, as discussed in FIG. 3A, a request may be an invocation for cryptographic operation received at a processor within the electronic device(e.g., the cryptographic provider 204). In the above step, the invocation or request may be created in response to a user or organization trying to set up cryptographic operations for their applications or systems in accordance with their business needs. Alternatively, the request may be created in response to an occurrence of an event on an electronic device (or some other computing device).

In some examples, a user can associate any type of state change as an event triggering an invocation for cryptographic operation. The event may be any state change associated with the electronic device, a user of the electronic device, or network associated with the electronic device. For example, deploying provisioning for a web application may be identified as an event. Furthermore, a user may designate any updates to policies, libraries, algorithms within libraries associated with cryptographic operations, or operating system as an event.

In some examples, an event may refer to a relevant change to contextual information. For example, a client may move into the enterprise network from outside of it, they may access data that is confidential as part of their application session. The move may enable a change to the context within which cryptography will be used. A state change to contextual information may affect the cipher solution selection. For example, the usage context for a particular use of crypto (e.g., a TLS-based VPN) changes (e.g., the user moves from inside to outside the corporate network, the organization changes its policy about something). In this case, an event trigger can generate automatically a request to the policy manager 208 to re-evaluate the crypto class or tag to be used.

Upon receiving the request, the electronic device (or a processor within the device) may initiate a cryptography API call for handling cryptography operations for processing the request. A processor of the electronic device (e.g., cryptography shim 206 as shown in FIG. 3A) may further intercept the API call. The API call may be diverted to the software or systems including the cryptographic selection system 201 discussed in FIG. 3A for handling cryptographic operations for the user's request.

In step 404, the electronic device retrieves one or more cryptographic policies from a module (e.g., 380) within a secure enclave within a trusted execution environment (e.g., 355). In the above step, the secure enclave is a private and secure storage area within a protected memory and other isolation mechanisms. As discussed in FIG. 3A and 3B, the electronic device or a processor of the electronic device (e.g., cryptographic provider 204) may send a query to a processor (e.g., the policy manager 208) residing on a secure enclave on a trusted execution environment using one or more APIs. In response, the electronic device may receive one or more policies for processing the user's requests or queries. Alternatively, the electronic device may retrieve a list of classes or tags (associated with one or more algorithms and/or libraries) corresponding to the one or more policies for processing the request received in step 402.

In step 406, the electronic device accesses one or more libraries accordance with the one or more cryptographic policies. Specifically, the electronic device (e.g., cryptographic provider 204) may send a query to a library manager 210 (e.g., processor within a secure enclave (e.g., 376) within a trusted execution environment) to verify or attest one or more libraries needed for processing the request (further described in step 408). Alternatively, the electronic device accesses one or more libraries in accordance with a list of classes or tags received at the electronic device based on a mapping of classes or tags to the one or more libraries or algorithms within a mapping table (e.g., 211).

In step 408, the electronic device attests the one or more libraries by verifying attested data associated with the one or more libraries within a module (e.g., 375) of a secure enclave of the trusted execution environment. For example, as discussed in FIG. 3B description, during set up or provisioning time for cryptographic agility, each permissible library undergoes a registration process where the cryptographic hash of the library is computed and the hash is digitally signed. The registration information is added to a module within a secure enclave (e.g., configuration block 373) within the trusted execution environment 355. During step 408, to attest one or more libraries, the electronic device (e.g., the cryptographic provider 204) may query a processor (e.g., the library manager 210) residing on the module of secure enclave (e.g., 375). The processor (e.g., the library manager 210) may cryptographically hash the one or more libraries and compare with signed versions within the secure enclave (e.g., configuration block 373) to check whether they have been tampered.

In step 410, the electronic device configures the cipher solution for the electronic device based on attesting the one or more libraries. For example, as shown in FIG. 3B, upon receiving authentication from the library manager 210 under step 408, the cryptographic provider 208 (e.g., a processor within the electronic device) may determine that selected algorithms within the libraries and/or algorithms (based on the received policies, tags or classes) are verified for processing the request and may configure them as a cipher solution for future requests. Alternatively, the electronic device may simply process the request by executing the authenticated libraries without specifically configuring a cipher solution for processing future requests. For example, as shown in FIG. 3B, the cryptographic provider 204 may call the one or more libraries for execution using the APIs supported by the library manager 210.

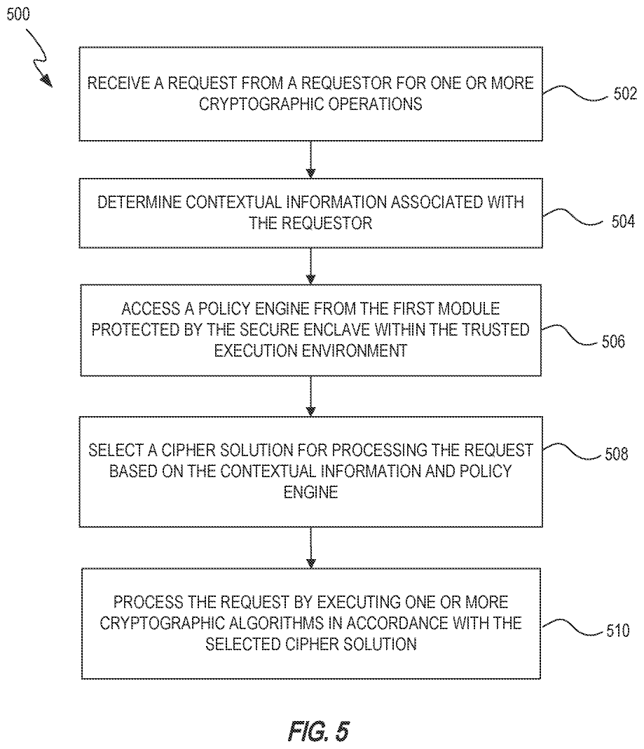

FIG. 5 shows a flow diagram illustrating a process for selecting a cipher solution based on contextual information using a trusted execution environment, in accordance with the embodiments described herein. The steps shown in FIG. 5 may be performed over one or more client or server devices or processors within a single electronic device. Alternatively, the steps shown in FIG. 5 may be performed by one or more processors within the cloud platform. In some examples, the steps as disclosed in FIG. 5 may be performed using one or more processors within the trusted execution environment.

In step 502, the electronic device may receive a request from a requestor for accessing one or more resources, creating a secure communication, or some other actions involving cryptographic operations. In the above step, the requestor is a user, an entity, an organization or a service using the electronic device. Alternatively, the request may be created in response to an occurrence of an event on an electronic device (or some other computing device). In some examples, users can associate any type of state change as an event, as discussed in FIG. 4 description.

In step 504, the electronic device may determine contextual information associated with the requestor. In the above step, contextual information may include information associated with the electronic device, a communication network used by the electronic device, an organization associated with the electronic device and a user of the electronic device. In some examples, the contextual information may include user data (e.g., user context 222) which can include data such as a user's location, the user's access level, the speed and/or characteristics of the local network the user is accessing, the geographic location of the user and more. In some examples, the contextual information may include device data or entity data (organization context 224) such as security measurements on the device, security requirements from the organization, and the like.

In step 506, the electronic device may access a policy engine 218 from a module of a secure enclave (e.g., 380) within a trusted execution environment (e.g., 355). For example, as shown in FIG. 3B, the policy engine 218 may reside within a secure enclave in a trusted execution environment 355. The policy engine (e.g., 218) may provide mapping information based on the contextual information determined in step 504. For example, in the above step, as discussed in FIG. 3B, the cryptographic provider 204 may query (using one or more APIs) a processor or manager within the policy manager enclave 380 to determine mapping policy, class, tags, and other information for the determined contextual information.

In step 508, the electronic device may determine a cipher solution for processing the request based on the contextual information and the information from the policy engine. In the above step, determining the cipher solution for processing the request includes selecting one or more libraries or one or more cryptographic algorithms within the one or more libraries based on policy information and tags and/or classes information in accordance with the contextual information. In some examples, a cipher solution may be a selection of the one or more libraries or one or more cryptographic algorithms within the one or more libraries.

In step 510, the electronic device may process the request by executing one or more cryptographic algorithms in accordance with the cipher solution. In the above step, processing the request by executing one or more cryptographic algorithms in accordance with the cipher solution includes performing at least one of decryption and/or encryption operations using the one or more cryptographic algorithms using one or more processors within the trusted execution environment. For example, as shown in FIG. 3B, the cryptographic provider 204 may call the one or more libraries for execution using the APIs supported by the library manager 210.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A computer-implemented method performed on an electronic device, comprising:
receiving a request for configuring a cipher solution for one or more cryptographic operations;
retrieving one or more cryptographic policies from a first module protected by a secure enclave within a trusted execution environment;
accessing one or more libraries in accordance with the one or more cryptographic policies;
attesting the one or more libraries by verifying attestation data associated with the one or more libraries within a second module protected by the secure enclave of the trusted execution environment; and
configuring the cipher solution for the electronic device based on attesting the one or more libraries.

2. The computer-implemented method of claim 1, further comprising:
in response to receiving the request:
determining contextual information associated with a requestor of the request;
accessing a policy engine from the first module protected secure enclave within the trusted execution environment;
selecting a cipher solution for processing the request based on the contextual information and the policy engine; and
processing the request by executing one or more cryptographic algorithms in accordance with the selected cipher solution.

3. The computer-implemented method of claim 1, wherein the secure enclave is a private and secure storage space within protected memory, wherein the first module is a first secure area within the secure enclave, and wherein the second module is a second secure area within the secure enclave.

4. The computer-implemented method of claim 1, wherein verifying attestation data associated with the one or more libraries includes verifying digital certificate or a hash key associated with each of the one or more libraries with the attestation data within the second module protected by the secure enclave.

5. The computer-implemented method of claim 2, wherein selecting the cipher solution for processing the request comprises:
identifying one or more tags or classes associated with the policy engine based on the contextual information; and
configuring the one or more tags or classes as the cipher solution for processing the request.

6. The computer-implemented method of claim 2, wherein processing the request by executing one or more cryptographic algorithms in accordance with the cipher solution comprises:
selecting one or more libraries or one or more cryptographic algorithms within the one or more libraries based on the selected cipher solution from a mapping table within a third module of the secure enclave;
configuring the one or more libraries or the one or more cryptographic algorithms within the one or more libraries; and
executing the one or more cryptographic algorithms based on the configured the one or more libraries or the one or more cryptographic algorithms for processing the request.

7. The computer-implemented method of claim 2, wherein a requestor is a user, an entity, an organization or a service using the electronic device.

8. The computer-implemented method as recited of claim 2, wherein the contextual information includes information associated with the electronic device, a communication network used by the electronic device, an organization associated with the electronic device and a user of the electronic device.

9. The computer-implemented method of claim 6, wherein the mapping table includes mapping between one or more cryptographic algorithms, one or more libraries, and one or more classes or tags.

10. The computer-implemented method of claim 1, wherein the request for the one or more cryptographic operations is to access at least one of electronic device data, communication network data, or one or more server applications.

11. A non-transitory computer-readable storage medium storing instructions configured to be executed by one or more processors of an electronic device to carry out steps that include:
receiving a request for configuring a cipher solution for one or more cryptographic operations;
retrieving one or more cryptographic policies from a first module protected by a secure enclave within a trusted execution environment;
accessing one or more libraries in accordance with the one or more cryptographic policies;
attesting the one or more libraries by verifying attestation data associated with the one or more libraries within a second module protected by the secure enclave of the trusted execution environment; and
configuring the cipher solution for the electronic device based on attesting the one or more libraries.

12. The non-transitory computer-readable storage medium of claim 11, further comprising:
in response to receiving the request:
determining contextual information associated with the requestor;
accessing a policy engine from the first module protected secure enclave within the trusted execution environment;
selecting a cipher solution for processing the request based on the contextual information and the policy engine; and
processing the request by executing one or more cryptographic algorithms in accordance with the selected cipher solution.

13. The non-transitory computer-readable storage medium of claim 11, wherein the secure enclave is a private and secure storage space within protected memory, wherein the first module is a first secure area within the secure enclave, and wherein the second module is a second secure area within the secure enclave.

14. The non-transitory computer-readable storage medium as recited in claim 11, wherein verifying attestation data associated with the one or more libraries includes verifying digital certificate or a hash key associated with each of the one or more libraries with the attestation data within the second module protected by the secure enclave.

15. The non-transitory computer-readable storage medium of claim 12, wherein processing the request by executing one or more cryptographic algorithms in accordance with the cipher solution comprises:
selecting one or more libraries or one or more cryptographic algorithms within the one or more libraries based on the selected cipher solution from a mapping table within a third module of the secure enclave;
configuring the one or more libraries or the one or more cryptographic algorithms within the one or more libraries; and
executing the one or more cryptographic algorithms based on the configured the one or more libraries or the one or more cryptographic algorithms for processing the request.

16. The non-transitory computer-readable storage medium of claim 12, wherein selecting the cipher solution for processing the request comprises:
identifying one or more tags or classes associated with the policy engine based on the contextual information; and
configuring the one or more tags or classes as the cipher solution for processing the request.

17. The non-transitory computer-readable storage medium as recited in claim 12, wherein a requestor is a user, an entity, an organization or a service using the electronic device.

18. The non-transitory computer-readable storage medium of claim 12, wherein the contextual information includes information associated with the electronic device, a communication network used by the electronic device, an organization associated with the electronic device and a user of the electronic device.

19. The non-transitory computer-readable storage medium of claim 15, wherein the mapping table includes mapping between one or more cryptographic algorithms, one or more libraries, and one or more classes or tags.

20. An electronic device, comprising:
one or more processors; and
memory storing one or more programs configured to be executed by the one or more processors, the one or more programs including instructions for:
receiving a request for configuring a cipher solution for one or more cryptographic operations;
retrieving one or more cryptographic policies from a first module protected by a secure enclave within a trusted execution environment;
accessing one or more libraries in accordance with the one or more cryptographic policies;
attesting the one or more libraries by verifying attestation data associated with the one or more libraries within a second module protected by the secure enclave of the trusted execution environment; and
configuring the cipher solution for the electronic device based on attesting the one or more libraries.
